(19) United States
(12) Patent Application Publication
(10) Pub. No.: US 2024/0157257 A1
(43) Pub. Date: May 16, 2024

(54) MODULAR GAMING SYSTEM

(71) Applicant: 9427-5906 QUÉBEC INC., Montreal (CA)

(72) Inventors: Marco Lurati, Ticino Lugaggia (CH); Luiz Brandao, Mont-Saint-Hilaire (CA); Ralph Nakhle, Montreal (CA)

(21) Appl. No.: 18/281,039

(22) PCT Filed: Mar. 10, 2022
(86) PCT No.: PCT/IB2022/052165

§ 371 Date: Sep. 8, 2023

Related U.S. Application Data
(60) Provisional application No. 63/158,925, filed on Mar. 10, 2021.

(51) Int. Cl. A63F 13/90; A63F 13/327

(52) U.S. Cl. CPC A63F 13/90; A63F 13/327

(57) ABSTRACT

A gaming apparatus including a body provided with at least two connection faces; at least two identifier units operatively connected with a respective one of the at least two connection faces and indicative of a module identifier (ID); at least two proximity sensing units operatively connected with a respective one of the at least two connection faces for detecting a connection with a gaming module; and a processor for determining the module ID of the gaming module, determining a face ID of a given one of the at least two connection faces that is connected to the gaming module, transmitting, via the communication interface, the module ID of the gaming module, the face ID and an own module ID, receiving an action to be executed, and executing the action.

### TECHNICAL FIELD

This present technology pertains to the field of modular gaming systems, and more particularly to methods and systems for detecting connection between modules in a modular gaming system.

### BACKGROUND

The rise of mobile phones and screen-based devices has skyrocketed in the past 10 to 15 years. A large portion of the population has grown increasingly addicted to mobile phones despite having been adults with a developed capacity to judge and make decisions when they first encountered the technology. Many children are developing addictions to screens from a very early age.

To improve this situation, it may be important to have healthy and well-planned introductory tools that initiate children to the digital realm and the range of its power.

Furthermore, traditional education follows a typical one-size-fits-all approach where children develop a subset of their skills and abilities

Current gaming systems use mostly screen-based interactions and do not have the flexibility to be customized and adapted to multiple game scenarios.

Therefore, there is a need for a modular gaming system customizable to different game scenarios and capable of detecting the connectivity between its components.

### SUMMARY

According to a first aspect of the present disclosure, there is provided a modular gaming system comprising: a plurality of modules each having at least two connection faces and each comprising: at least two identifier units each operatively connected with a respective one of the at least two connection faces and indicative of a module identifier (ID); and at least two proximity sensing units each operatively connected with a respective one of the at least two connection faces for detecting a connection with another one of the plurality of modules; a communication interface; and a processor in communication with the at least two proximity sensing units, the processor for: determining the module ID of the other one of the plurality of modules; determining a face ID of a given one of the at least two connection faces that is connected to the other one of the plurality of modules; and transmitting, via the communication interface, the module ID of the other one of the plurality of modules, the face ID and an own module ID; and a data processing module for: receiving the module ID of the other one of the plurality of modules, the face ID and the own module ID from a first module and a second module of the plurality of modules; identifying a given one of the at least two connection faces of the first module and a particular one of the at least two connection faces of the second module that are connected together, based on the module ID of the other one of the plurality of modules, the face ID and the own module ID received from the first and second modules, thereby obtaining an identification result; and triggering an event based on the identification result.

In one embodiment, the at least two identifier units each comprise a magnetic field generator for emitting a magnetic field having a characteristic representative of the module ID.

In one embodiment, the magnetic field generator comprises a set of magnets defining a unique arrangement of polarity values and intensity values representative of the module ID.

In one embodiment, the at least two proximity sensing units each comprise a set of magnetic field sensors for detecting the sets of magnets of the other one of the plurality of modules and thereby obtaining the module ID of the other one of the plurality of modules.

In one embodiment, the at least two proximity sensing units each comprise a set of magnetically activable switches for detecting the set of magnets of the other one of the plurality of modules and thereby obtaining the module ID of the other one of the plurality of modules.

In one embodiment, the at least two identifier units each comprise a set of bodies representative of the module ID; and wherein the at least two proximity sensing units each comprise a set of capacitive sensors for detecting the set of plates of the other one of the plurality of modules and thereby obtaining the module ID of the other one of the plurality of modules.

In one embodiment, the set of bodies comprise at least one of: at least one conductive plate; and at least one non-conductive plate.

In one embodiment, the data processing module is configured for comparing said identification result to an expected result to determine the event.

In one embodiment, the processor is configured for determining the face ID by identifying a given one of the at least two sensing units that detects the connection with the other one of the modules.

In one embodiment, the plurality of modules and the data processing module each have a cubic shape.

In one embodiment, each one of the plurality of modules further comprises at least one of a speaker and a light source, the event comprising one of emitting a sound via the speaker and activating the light source.

According to another broad aspect, there is provided a gaming apparatus comprising: a body defining an internal chamber and provided with at least two connection faces; at least two identifier units each operatively connected with a respective one of the at least two connection faces and indicative of a module identifier (ID); at least two proximity sensing units each operatively connected, within the chamber, with a respective one of the at least two connection faces for detecting a connection with a gaming module; a communication interface mounted into the chamber; and a processor mounted into the chamber and in communication with the at least two proximity sensing units, the processor for: determining the module ID of the gaming module; determining a face ID of a given one of the at least two connection faces that is connected to the gaming module; and transmitting, via the communication interface, the module ID of the gaming module, the face ID and an own module ID; receiving an action to be executed in response to said transmitting the module of the gaming module ID, the face ID and the own module ID; and executing the action.

In one embodiment, the gaming apparatus further comprises at least two identical magnetic field generators each operatively connected with the respective one of the at least two connection faces, the at least two identical magnetic field generators emitting a magnetic field having a characteristic representative of the module ID.

In one embodiment, the magnetic field generator comprises a set of magnets defining a unique arrangement of polarity values and intensity values representative of the module ID.

In one embodiment, each of the at least two proximity sensing units comprises a set of magnetic field sensors for detecting the set of magnets of the gaming module and thereby obtaining the module ID of the gaming module.

In one embodiment, each of the at least two proximity sensing units comprises a set of magnetically activable switches for detecting the set of magnets of the gaming module, and thereby obtaining the module ID of the gaming module.

In one embodiment, each of the at least two identifier units comprises a set of bodies representative of the module ID; and wherein each of the at least two proximity sensing units comprises a set of capacitive sensors for detecting the set of bodies of the gaming module and thereby obtaining the module ID of the gaming module.

In one embodiment, the set of bodies comprise at least one of: at least one conductive plate; and at least one non-conductive plate.

In one embodiment, the processor is configured for determining the face ID by identifying a given one of the at least two sensing units that detects the connection with the other one of the modules.

In one embodiment, the body has a cubic shape.

In one embodiment, the gaming apparatus further comprises at least one of a speaker and a light source, said action to be executed comprising one of emitting a sound via the speaker and activating the light source.

According to a further broad aspect, there is provided a method for detection a connection between a first gaming module and a second gaming module, the method being executed by a processor, the method comprising: receiving from a first gaming module: a first identification (ID) of a second gaming module; a second ID of a given face of the first gaming module; a third ID identifying the first gaming module; receiving from the second gaming module: the third ID of the first gaming module; a fourth ID of a given face of the second gaming module; a first ID of the second gaming module; determining that the given face of the first gaming module is connected to the given face of the second gaming module based on the first ID, the second ID, the third ID and the fourth ID, thereby obtaining an identification result; and triggering an event based on the identification result.

In one embodiment, said triggering an event comprises retrieving an action to be executed based on the comparison result.

In one embodiment, said triggering an event further comprises executing the action.

In one embodiment, said triggering an event further comprises transmitting the action to at least one of the first and second gaming modules.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

The present technology is directed to a modular gaming system having a plurality of gaming or slave modules interconnectable with each other and a central or master module or data processing module controlling the gaming modules and capable of supporting a plurality of games. The central module can as well be interconnectable with the gaming modules. Numerous game scenarios can be designed and played using the modular gaming system of the present disclosure. In at least some game scenarios, a user may be asked to connect a particular face of a gaming module to a particular face of another gaming module. In this case, in order to determine whether the user succeeded in connecting together the instructed faces of the gaming modules, the central module must determine which faces of gaming modules have been connected by the user. In the following, there is described a method and system for making such a determination.

The gaming system comprises a central module and at least two gaming modules. Each gaming module is provided with at least two connection faces for connection to at least another gaming module. In one embodiment, the central module is also connectable to a gaming module and comprises at least connection faces. A connection face is a face of a module that can be connected to another module such as to a connection face of another gaming module and is provided with an ID unit and a proximity sensing unit. Each gaming module is provided with a processor, a memory or storing unit, a communication interface for receiving and/or transmitting data and a power source such as a rechargeable battery. Each gaming module is provided with a unique module identification (ID), and within a gaming module, each connection face is provided with a unique face ID. For example, in a gaming system comprising two gaming modules each having three connection face, the gaming modules may be identified as gaming module 1 and gaming module 2, and for each gaming module, the connection faces may be identified as connection face 1, connection face 2 and connection face 3. In this case, the connection face 2 of the gaming module 1 may be connected to the connection face 1 of the gaming module 2, the connection face 3 of the gaming module 1 may be connected to the connection face 3 of the gaming module 2, etc.

Each connection face of each gaming module is provided with a proximity sensing unit and an ID unit. For each gaming module, the ID unit of each connection face is indicative of the module ID and the proximity sensing unit of each connection face is adapted to detect a connection of the connection face with another gaming module by detecting an ID unit of the other gaming module. The proximity sensing unit is further configured for determining the module ID associated with the detected ID unit. In other words, a proximity sensor is configured for reading the module ID associated with an ID unit that is detected by the proximity sensing unit.

The processor of each gaming module is configured for, upon detection of a connection with another gaming module by one of its proximity sensors, identifying its connection face that is connected to the other gaming module, identifying the other gaming module to which it is connected and transmitting the ID of the its connection face that is connected to the other gaming module, the ID of the other gaming module to which it is connected and its own ID to the central module. The central module receives the ID information from at least two gaming modules and identifies the connection scheme between the connection faces of the gaming modules, i.e., it determines which connection face of which gaming module is connected to which connection face of which other gaming module, based on the ID information received from the gaming modules.

Upon detection of an ID unit, a proximity sensing unit generates sensing data which are indicative of the module ID associated with the ID unit of a detected gaming module. As described in greater detail below, the sensing data may comprise amplitude(s), polarity value(s), wavelength(s), and/or the like. The sensing data is transmitted by the proximity sensing unit to the processor of its own gaming module. In one embodiment, the ID of the detected gaming module transmitted by the gaming module to the main module comprises the sensing data received from the proximity sensing unit and the processor of the main module is then configured for identifying the detected gaming module based on the received sensing data. In another embodiment, the processor of gaming module is configured for retrieving the module ID of the detected gaming module based on the sensing data and transmitting the module ID to the main module.

In one embodiment, the central module is physically connectable to the gaming modules. In this case, the structure of the central module is the same as that of a gaming module, except for its processor which is further configured for determining the connection scheme between the connection faces of the gaming modules.

In another embodiment, the central module is not connectable to the gaming modules. In this case, the central module may be a computer, a smartphone, a tablet, etc.

As described in greater detail below, the proximity sensing unit may be any adequate proximity sensing configured for detecting a gaming module and reading the module ID of the detected gaming module to generate sensing data indicative of the module ID of the detected gaming module.

In one embodiment, the ID unit is adapted to generate an electromagnetic field of which the value of at least one parameter or characteristic is indicative of a unique module ID and the proximity sensing unit is adapted to detect the electromagnetic field emitted by the ID unit and measure the value of the parameter(s) indicative of the module ID.

In one embodiment, the ID unit is adapted to emit a magnetic field. The ID unit may comprise at least one magnet, at least one coil, etc. The value of at least one parameter or characteristic of the magnetic field such as the amplitude or the polarity is then indicative of the module ID associated with the ID unit. For example, an ID unit may comprise a plurality of magnets each emitting a magnetic field having a respective amplitude and polarity. In one embodiment, the proximity sensing unit comprises at least one magnetic field sensor configured for measuring the amplitude and/or the polarity of at least one magnetic field. The measured characteristics of the magnetic field are then indicative of the module ID associated with the ID unit. In another embodiment, the proximity sensing unit comprises at least one magnetically activable switch used as magnetic field sensor since a magnetically activable switch activates in the presence of a magnetic field. For example, an ID unit may comprise at least one magnet and a proximity sensing unit may comprise two magnetically activable switch. The position and the number of magnets are indicative of a module ID. For example, two magnets present in the ID unit correspond to a first module ID, a magnet on the left side of the ID unit and no magnet on the right side correspond to a second module ID and no magnet on the left side and a magnet on the right side correspond to a third module ID. The proximity sensing unit can then determine the module ID associated with an ID unit based on the number and position of the magnetically activable switches that are activated. For example, if the two magnetically activable switches are activated, then the proximity sensing unit identifies the detected ID unit as having the first module ID.

In another embodiment, the ID unit is adapted to emit light and the proximity sensing unit is adapted to detect light. For example, the ID unit may comprise at least one light source for emitting at least one light beam of which at least one parameter or characteristic is indicative of a module ID. For example, the amplitude, the wavelength, the polarity, etc. can be used for creating different unique module IDs. It will be understood that the proximity sensing unit is then configured for detecting the light and measure the value of the parameter(s) of the detected light.

In a further embodiment, the ID unit comprises at least one body such as a plate and the proximity sensing unit comprises at least one capacitive sensor each for detecting a respective body. The body(ies) contained in the ID unit may be conductive or non-conductive. Characteristics of the body(ies) such as the type of material, the thickness, etc. are used for creating different unique module IDs.

It will be understood that the positioning of the ID units and the proximity sensing units within a gaming module is chosen so that, when two connection faces of two different gaming modules are connected, the proximity sensing unit of one gaming module can detect the ID unit of the other gaming module and vice versa. This may be achieved by ensuring that a predetermined alignment between two gaming modules exists when two gaming modules are connected together. It should be understood that any adequate alignment feature, mechanism and/or method may be used.

In one embodiment, the ID units and the proximity sensing unit have the same location on each connection face of each gaming module, thereby ensuring that any ID unit of any gaming module can be detected by the proximity sensing unit of any other gaming module.

FIG. 1A shows an exemplary gaming module 100 having a cubic shape that can be used to implement the gaming module of the modular gaming system. The gaming system comprises a central module and at least two gaming module 100.

Embodiments of the present technology provide for the gaming modules to be interconnectable through identifiable connection faces. It should be understood that any adequate method for removably connecting together two gaming modules may be used. For example, a connection between two modules can be done by physically and removably securing together the two gaming modules or by having the two gaming modules within a predefined range of proximity of each other. Using the example of the cubic gaming module 100, the lateral faces of the cube 100 are connection faces, i.e., they are connectable to other gaming modules or to the central module while the top and bottom faces are not connectable faces, i.e., they cannot connect to another gaming module or to the central module. A connection mechanism can be associated with each connection face of each module to allow for two modules to removably connect together. In one embodiment, the connection mechanism can be based on magnetic forces that enable two gaming modules to snap together. An exemplary connection mechanism using magnetic forces is described in greater detail below.

In another example, a mechanical switch can be used to snap the modules together. Other mechanisms, known to those skilled in the art can be used to snap together the modules.

Embodiments of the present technology provide for each connection face to have a proximity sensor for detecting when a connection face of a gaming module is connected to a connection face of a neighboring module. The details of the proximity sensor will be described herein after.

In one embodiment, the module 100 can be provided with an interaction mechanism to receive inputs from a user and/or to output information to the user. In one embodiment, the interaction mechanism includes a display 120 provided on a top surface of the module 100 to signal information to the user. The display 120 can be an LED matrix or other display types that can be used to signal information to a user. The display 120 can be used in a game to display a particular color, a pattern of color or any other character for the purpose of the game. It should be understood that the gaming module 100 is further provided with a power source for powering the other components such as the proximity sensors, the interaction mechanism, etc.

In one embodiment, the interaction mechanism comprises a speaker 130 for playing back an audio signal to the user. The speaker 130 can be used to give feedback to the player following an action such as sounds indicative of correct and incorrect answers, sounds indicative of the start and/or end of games, sounds indicating that the battery needs charging or any audible feedback in a context of a game. The interaction mechanism can include, as well, a button 140 for activating the gaming module, a function of the gaming module or for providing an input as part of a game. For example, in a game where a color needs to be selected, like the “Color Smash” game, the player may press the button 140 of the gaming module which displays the right color to provide the answer. In one embodiment, the interaction mechanism can include at least one light source.

Embodiments of the modular gaming system provide for the gaming module to be implemented as a slave module with no interaction mechanism. In these embodiments, the gaming module are under the control of the central module which direct the gaming modules to act or behave according to its instructions and to report back to the central module. In these embodiments, user interactivity is done through the central module.

Embodiments of the present system provide for each gaming module to have a unique identifier referred as a module identifier. In these embodiments, each gaming module when connected to another gaming module can communicate to the central module its own module identifier and the module identifier of the other gaming module to which it is connected. In one embodiment, each connection face of a same module has an identifier and the identifier of the connection face through which the module connects to the other module can as well be communicated to the central module. Details for identifying the module identifier and the connection face identifier are described herein after.

Embodiments of the present technology provide for the modular gaming system to have each face of the gaming modules with a preset color. In these embodiments, a player may be asked to connect faces with specified colors and, upon connecting the cubes, the central module can receive the identifiers of the gaming modules connected together along with the identifier of the face through which a gaming module connects to another gaming module to determine whether the player has correctly assembled the gaming modules.

The module 100 which can be used to implement the gaming module has been described as having a cubic shape, i.e. the module 100 comprises a cubic frame or body defining an internal chamber or cavity for receiving components therein. However, it will be understood that a gaming module may be provided with a different shape. For example, the gaming module can be a polyhedron with a specified number of connection faces that allow for snap or proximity connection to a neighbor module. Those skilled in the art will recognize that different shapes can be used in the design without departing from the teaching of the present technology.

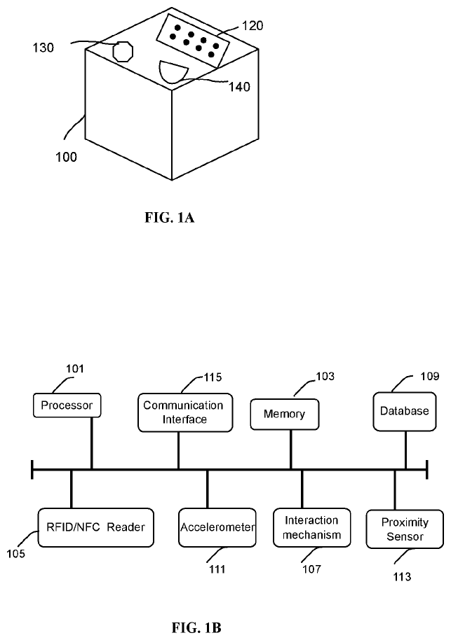

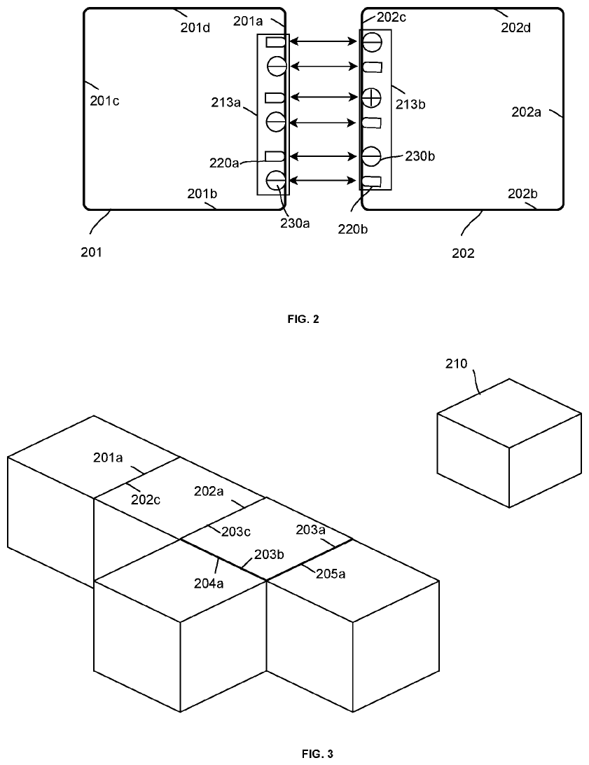

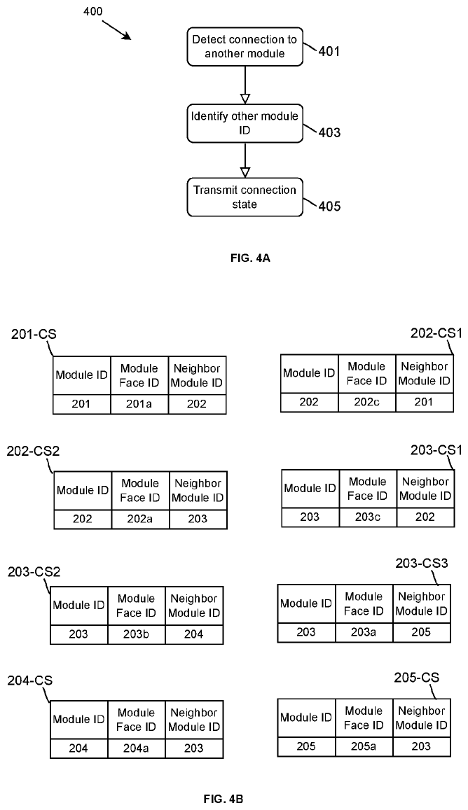

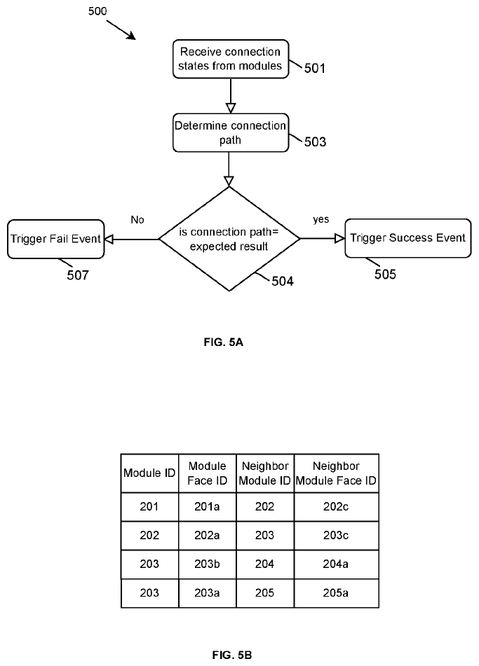

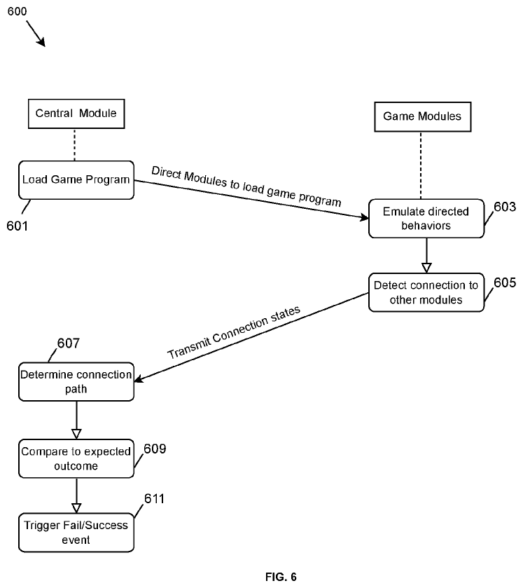

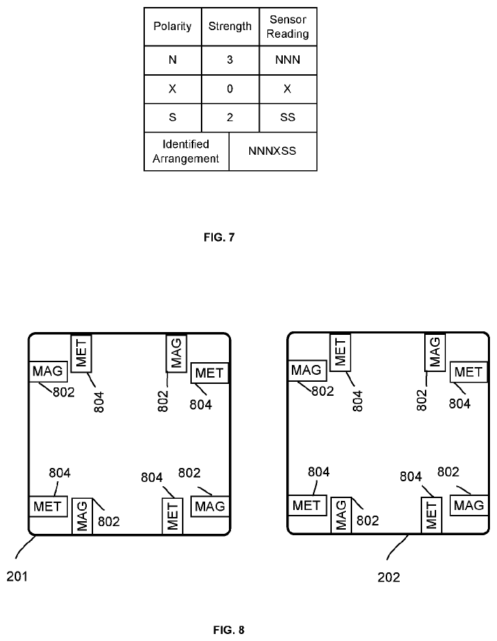

In one embodiment, the central module or data processing module controlling the gaming modules can be implemented as having the same shape as the gaming module, such as the cubic module 100. In this embodiment, the central module is configured with added functionalities, with respect to the gaming module 100, to perform its control and central roles as will be described with regard to FIG. 1B. In one embodiment, the central module is implemented as part of an application running on a device such as a computer or a smartphone.

FIG. 1B illustrates a block diagram of a system for implementing the central module. The system comprises a processor 101 and a memory 103 capable of storing program instructions for execution by the processor 101. The processor 101 can be a microprocessor or any processing unit capable of performing the various operations of the present technology, such processing units being known to those skilled in the art. The system of FIG. 1B comprises a database 109 for storing information related to the different gaming modules including their identifier. The database 109 can as well store various games enabled on the modular gaming system.

A communication interface 115 is provided with the data processing module for communicating with the gaming modules and for communicating with external devices such as a computer or smartphone. The communication interface 115 can implement WITT Bluetooth or other communication interface used in local networks or proximity area networks. Each gaming module can be provided with the same communication interface 115 to communicate with the central module or to communicate with the other gaming modules.

In one embodiment, a communication interface based on ESP-NOW can be used to communicate between devices of the modular gaming system.

Embodiments of the present technology provide for the data processing module to identify a game ID and to run the corresponding game. The game ID can be communicated to the data processing module from the external device using the communication interface 115. Alternatively, the game ID can be identified by reading a game card through the RFID/NFC reader 105 present on the data processing module.

In one embodiment, the data processing module includes an interaction mechanism 107 such as a display, a speaker and/or an activation button for interfacing with a user, as described above with regard to the module 100.

In one embodiment, an accelerometer 111 is provided with the data processing module to detect a movement of the data processing module such as shakes, tilts, rolls, falls or any other type of movement based on acceleration. Alternatively, a gyroscope or an inertial measurement unit can be used to detect such movements.

Embodiments of the present technology provide for the data processing module to include a proximity sensor 113 for detecting gaming modules connected to the different connections faces of the data processing module. In these embodiments, each connection face is provided with a proximity sensor 113 to detect its connection to another gaming module and to determine the module identifier of the other gaming module.

In one embodiment, the data processing module further comprises an ID unit indicative of the module identifier. As described above, the ID unit may be a magnetic field generator such as a coil, a light source, etc. of which the value of at least one parameter is indicative of a module identifier.

In one embodiment, the proximity sensor 113 comprises a set of magnetic field sensors and the ID unit comprises at least one magnet. In one embodiment, the magnetic field sensors and the magnets of a same connection face are arranged along a line and the magnetic field sensors can be interspersed or interleaved with the magnets as illustrated in FIG. 2.

In one embodiment, the proximity sensor 113 can implement capacitive sensing by having a metal plate which, when aligned with another metal plate of another proximity sensor of the neighbor module for a connection, form a capacitor. In capacitive sensing, a current circulating through the capacitor formed with the two metal plates is used to sense the presence of the neighbor module.

Embodiments of the present technology provide for other sensing mechanisms to be used. For example, the detection of a connection can be based on detecting light from the neighbor module when the two modules are aligned. For example, a light source on the neighbor module can be detected by a light detector on the module by detecting light emitted by the light source. Characteristics such as light amplitude, wavelength, etc. may be used to provide a unique ID for each module.

The system shown in the block diagram illustrated in FIG. 1B has been described as implementing the central module however it is understood that such a system can be used to implement other functionalities. In one embodiment, the block diagram described in FIG. 1B is used to implement the gaming modules of the modular gaming system by running the necessary programs to emulate the functionalities of a gaming module.

FIG. 2 illustrates a connection of two neighboring gaming modules according to an embodiment of the present technology. FIG. 2 depicts a top view of two gaming modules 201 and 202 having a cubic shape and connected through their respective connection face 201a and 202c. The gaming module 201 has an ID and sensing unit 213a on its connection face 201a and the gaming module 202 has an ID and sensing unit 213b on its connection face 202c. FIG. 2 shows one proximity sensor for each module for illustration purpose only, however it is understood, as described above, that each connection face (201a, 201b, 201c, 201d, 202a, 202b, 202c and 202b) has a respective ID and sensing unit present. Each ID and sensing unit 231a, 213b comprises a proximity sensing unit and an ID unit indicative of the ID of its own module.

The ID and sensing unit 213a comprises a set of magnetic sensors 220a interspersed with a set of magnets 230a. The set of magnets 230a is indicative of the ID of the gaming module 201. The ID and sensing unit 213b comprises a set of magnetic sensors 220b interspersed with a set of magnets 230b. The set of magnets 230b is indicative of the ID of the gaming module 202. Each magnet 203a, 230b has a defined polarity based on a 3-state configuration, namely North, South and X for magnet absent, which is detectable by the sensor 220. The set of magnets 230a and 230b defines an arrangement of polarity values representative of the identifier of its respective module. As illustrated in FIG. 2, the array of magnets 230a is provided with an arrangement of polarity values south-south-south (SSS) which can be represented binarily and is indicative of the ID of the gaming module 201. The polarity values SSS or its binary representation is then representative of the ID of the gaming module 201. In this embodiment, all connection faces of a module 201 are provided with an identical set of magnets 230a. Similarly, the array of magnets 230b is provided with an arrangement of polarity values south-north-south (SNS) which can be represented binarily and is indicative of the ID of the gaming module 202. The polarity values SNS or its binary representation is then representative of the ID of the gaming module 202. In this embodiment, all connection faces of a module 202 are provided with an identical set of magnets 230b.

Embodiments of the present technology provide also for the array of magnets 230a, 230b to define an arrangement of polarity values and/or intensity values that can be used to identify the module 201, 202 by using a combination of magnets emitting different amplitude magnetic fields in the magnetic array. For example, a magnet with a double intensity value and a south polarity value read by the sensor could be detected as SS. FIG. 7 shows a table illustrating an exemplary arrangement of polarity values and intensity values along with the values read by the sensors.

In one embodiment, the ID and sensing units 213a and 213b are configured to have the array of sensors 220a of the module 201 align with the array of magnets 230b on the module 202 and have the array of sensors 220b of the module 202 align with the array of magnets 230a on the module 201 when modules 201 and 202 are connected, as illustrated in FIG. 2, i.e., when modules 201 and 202 are connected together, each magnet 230a of the module 201 faces a respective sensor 220b of the module 202 and each magnet 230b of the module 202 faces a respective sensor 220a of the module 201 The alignment can be enforced by having slots placed in the cube enclosure that guide an electric board containing the sensors to align with slots containing the magnets.

In the illustrated embodiment, the alignment between magnets of one module 201, 202 and the sensors of the other module 201, 202 upon connection between the two modules 201 and 202 is ensured by having the magnets and the sensors located at the exact same position on any connection face of the modules 201 and 202. As a result,

Embodiments of the present technology provide for the prevention or detection of misalignment of the modules being connected. In these embodiments, the magnets 230a, 230b located at the edges of the modules are prevented from having an X-state, i.e., a magnet 230a, 230b must be present at the first and last position in the array of magnet. For example, for a configuration with 3 possible magnets as illustrated in FIG. 2, only the middle slot can be empty and therefore can have an X-state. In this case, the array of magnets only comprise two magnet located at positions 1 and 3 within the array while no magnet is present at the position 2.

In one embodiment, the size of each magnet is set as to prevent the magnets from interfering in the snapping process by repelling the cubes. For example, the size of each magnet can be set to 3 mms in diameter and 1 mm in thickness. Those skilled in the art can recognize that other sizes for the magnet can be set as to have characteristics that enable their reliable detection by the sensors while preventing repelling actions.

While the number of sensors 220a, 220b and magnets 230a, 230b is illustratively set to three in FIG. 2, those skilled in the art will recognize that a different number of sensors and magnets can be used based on the size of the gaming modules and the number of gaming modules. For example, for a bigger size module, more sensors and magnets can be fit on the proximity sensors which incidentally allow to have a higher number of identifiers and therefore a higher number of gaming modules.

In operation, when modules 201 and 202 are connected, each sensor 220a of the module 201 detects a magnetic field above a configured threshold of a respective magnet 230b on the module 202 and can read their polarity values (SNS) and their strength, when enabled. Likewise, the sensors 220b of the module 202 read the arrangement of polarity values (SSS) of the magnets 230a on the module 201 and their strength, when enabled.

In one embodiment, each gaming module reports to the central module a connection state for each connection face connected to a neighbor module. The connection state identifies the module ID, the module connection face ID and the neighbor module ID, i.e., the ID of the gaming module to which it is connected. The module 201 will report the connection state 201-CS represented in FIG. 4B as (Module ID=201; Module face ID=201a; Neighbor module ID=202) and the module 202 will report the connection state 202-CS1 shown in FIG. 4B and represented as (Module ID=202; Module face ID=202c; Neighbor module ID=201). The module identifiers can be represented in the connection states using the polarity values arrangement or their binary equivalent as described above.

Each module 201, 202 transmits its own module ID, its connection face ID and its neighbor module ID to the main module which determines the connection scheme between the modules 201 and 202, i.e. it identifies the given connection face of the module 201 and the given connection face of the module 202 that are connected together. In the present case, the main module determines that the connection face 201a of the module 201 is connected to the connection face 202c of the module 202.

In one embodiment, the neighbor ID module comprises the sensed or measured data, i.e. the output of the sensing unit. In this case and with reference to FIG. 2, the neighbor ID transmitted to the main module by the module 201 is the output of the sensors 220a, i.e. SNS, and the neighbor ID transmitted to the main module by the module 202 is the output of the sensors 220b, i.e., SSS. In this case, the main module is configured for retrieving the IDs of the two connected modules 201 and 202 from a database based on the received measured data.

In another embodiment, the identification of the neighbor module is performed locally by the gaming module and the identification of the neighbor module is transmitted by the gaming module to the main module. In this case, the processor of the module 201 is configured for retrieving the ID of its neighbor module 202 from a database based on the measured data, i.e., SSS, and the processor of the module 202 is configured for retrieving the ID of its neighbor module 201 from a database based on the measured data, i.e., SNS. It will be understood that the database may be stored locally on the memory of the gaming module. Alternatively, the database may be stored remotely such as in the main module.

FIG. 3 shows a plurality of gaming modules 201, 201, 203 and 204 connected in a certain pattern and the central module 210. The connection between the modules shown in FIG. 3 may represent a response provided by a user for a game being played. For example, the game may be to replicate a certain pattern of colors displayed on the central module 210 and each gaming module emulates a given color selected from the pattern of colors. In this example, the user can connect the gaming modules to replicate such a pattern. Each connected module reports the connection state for each of its connection faces to the central module 210 which evaluates the assembled color pattern against the original pattern and trigger an event to signal to the user whether the pattern has been correctly identified or not.

The operation of the gaming modules 201, 202, 203, 204 and 205 shown as connected in a specified manner by the user in FIG. 3 will be described with respect to the flowchart 400 of FIG. 4A and the set of connection states depicted in FIG. 4B. Likewise the operation of the central module 210 will be described with respect to the flowchart 500 of FIG. 5A and the connection path depicted in FIG. 5B

At step 401 of the flowchart 400, a gaming module detects its connection to another or neighbor module through one of its connection faces. At step 403, the module identifies the module ID of the other module and transmits, at step 405, the connection state to the central module 210. As described above the neighbor module ID can be identified by reading the arrangement of polarity values of the magnets in the proximity sensor of the neighbor module. In one embodiment, the neighbor module ID is identified by an arrangement of polarity values and intensity values as described earlier.

Embodiments of the present technology provide for two connected gaming modules to directly communicate their own module ID to each other. For example, in an embodiment where the proximity sensors are not configured to read the neighbor module ID, the neighbor gaming module may communicate its own module ID to the connected gaming module through its communication interface.

The connection states of the gaming modules 201, 202, 203, 203 and 205 are shown in FIG. 4B. Each gaming module reports the connection states at its connection faces. For example, module 201 with only one connection to the module 202, reports the connection state at its connection face 201a. Module 203, with 3 connections to modules 202, 204 and 205 reports the connection states 203-CS1, 203-CS2 and 203-CS2 to the central module 210.

FIG. 5A illustration an operation of the central module 210 according to an embodiment. At step 501 of the flowchart 500, the central module 210 receives the connection states from all the gaming modules 201, 202, 203, 204 and 205. At step 503, the central module 201 processes the connection states to determine a connection path between all modules by determining which gaming modules are connected to each other and through which connection faces. FIG. 5B shows a connection path in tabular format in which each row identifies two connected modules and their two connection faces: {(201a-202c); (202a-203c); (203b-204a); (203a-205a)}.

At step 504 of the flowchart 500, the central module 210 compares the determined connection path, which is the user response to the game being played, as described above, with an expected result. If the user response corresponds to the expected result, the central module can trigger a success event, at step 505, signaling to the user that the response is correct. If the user response differs from the expected result, fail event is triggered at step 507.

In one embodiment, an event can be triggered by displaying on the central module a specific color or by voicing through the speaker the event type. For example, the central module can direct one or more gaming modules to play a certain sound, flash a light or display a character. Different ways to signal to the user the outcome of the game can be devised using the interactive mechanism 107 on the central module or on one or more of the gaming modules.

FIG. 6 shows a flowchart 600 depicting an operation of the modular gaming system. In operation, the central module 201, at step 601, loads a game stored in its database 109 or it can download the game from an external repository and executes the game through its processor. In one embodiment, the central module can direct the gaming modules to load a client version of the game. At step 603, the gaming modules emulate the behavior according to the game instructions. For example, each game module may show a specific color through its display as to allow the user to replicate the color pattern displayed on the central module. At step 605, upon a user connecting the modules as shown in FIG. 3 to replicate the color pattern, each gaming module identifies its neighbor gaming modules and determines the connection states associated to the faces that are connected to a neighbor gaming module. The connection states are thereafter transmitted to the central module 210. At step 607, the connection path is determined as described above to evaluate the response of the user against an expected result such as the original color pattern, at step 609. At step 611 a fail or success event is triggered according to the result of the evaluation of step 609 as previously described.

FIG. 8 illustrates an exemplary connection mechanism between two gaming modules using magnetic forces to connect together the two modules. As illustrated, each face of the modules 201 and 202 has a magnet 802 and a metal plate 804. In operation, the metal plate 804 of the module 201 aligns with the magnet 802 of the module 202 and the magnet 802 of the module 201 aligns with metal plate 804 of the module 202 thus creating an attractive magnetic force between the two modules to connect together the modules.

In one embodiment, the magnet 804 is set such that its intensity does not interfere with the magnets and magnetic sensors of the proximity sensor present on each face of the modules.

In one embodiment, the connection mechanism may use magnets with inverse polarity to connect the two modules. In this embodiment, the metal plate 804 could be replaced with a magnet having a polarity inverse to the polarity of the magnet 802. Other connection mechanisms to removably connect two modules together can be used and are within the scope of the present disclosure.

Modifications and improvements to the above-described implementations of the present technology may become apparent to those skilled in the art. The foregoing description is intended to be exemplary rather than limiting.

1. A modular gaming system comprising:
a plurality of modules each having at least two connection faces and each comprising:
at least two identifier units each operatively connected with a respective one of the at least two connection faces and indicative of a module identifier (ID); and
at least two proximity sensing units each operatively connected with a respective one of the at least two connection faces for detecting a connection with another one of the plurality of modules;
a communication interface; and
a processor in communication with the at least two proximity sensing units, the processor for:
determining the module ID of the other one of the plurality of modules;
determining a face ID of a given one of the at least two connection faces that is connected to the other one of the plurality of modules; and
transmitting, via the communication interface, the module ID of the other one of the plurality of modules, the face ID and an own module ID; and
a data processing module for:
receiving the module ID of the other one of the plurality of modules, the face ID and the own module ID from a first module and a second module of the plurality of modules;
identifying a given one of the at least two connection faces of the first module and a particular one of the at least two connection faces of the second module that are connected together, based on the module ID of the other one of the plurality of modules, the face ID and the own module ID received from the first and second modules, thereby obtaining an identification result; and
triggering an event based on the identification result.

2. The modular gaming system of claim 1, wherein the at least two identifier units each comprise a magnetic field generator for emitting a magnetic field having a characteristic representative of the module ID.

3. The modular gaming system of claim 2, wherein the magnetic field generator comprises a set of magnets defining a unique arrangement of polarity values and intensity values representative of the module ID.

4. The modular gaming system of claim 3, wherein the at least two proximity sensing units each comprise a set of magnetic field sensors for detecting the sets of magnets of the other one of the plurality of modules and thereby obtaining the module ID of the other one of the plurality of modules.

5. The modular gaming system of claim 3, wherein the at least two proximity sensing units each comprise a set of magnetically activable switches for detecting the set of magnets of the other one of the plurality of modules and thereby obtaining the module ID of the other one of the plurality of modules.

6. The modular gaming system of claim 1, wherein the at least two identifier units each comprise a set of bodies representative of the module ID; and
wherein the at least two proximity sensing units each comprise a set of capacitive sensors for detecting the set of plates of the other one of the plurality of modules and thereby obtaining the module ID of the other one of the plurality of modules.

7. The modular gaming system of claim 6, wherein the set of bodies comprise at least one of:
at least one conductive plate; and
at least one non-conductive plate.

8. The modular gaming system of claim 1, wherein the data processing module is configured for comparing said identification result to an expected result to determine the event.

9. The modular gaming system of claim 1, wherein the processor is configured for determining the face ID by identifying a given one of the at least two sensing units that detects the connection with the other one of the modules.

10. (canceled)

11. The gaming system of claim claim 1, wherein each one of the plurality of modules further comprises at least one of a speaker and a light source, the event comprising one of emitting a sound via the speaker and activating the light source.

12. A gaming apparatus comprising:
a body defining an internal chamber and provided with at least two connection faces;
at least two identifier units each operatively connected with a respective one of the at least two connection faces and indicative of a module identifier (ID);
at least two proximity sensing units each operatively connected, within the chamber, with a respective one of the at least two connection faces for detecting a connection with a gaming module;
a communication interface mounted into the chamber; and
a processor mounted into the chamber and in communication with the at least two proximity sensing units, the processor for:
determining the module ID of the gaming module;
determining a face ID of a given one of the at least two connection faces that is connected to the gaming module; and
transmitting, via the communication interface, the module ID of the gaming module, the face ID and an own module ID;
receiving an action to be executed in response to said transmitting the module of the gaming module ID, the face ID and the own module ID; and
executing the action.

13. The gaming apparatus of claim 12, further comprising at least two identical magnetic field generators each operatively connected with the respective one of the at least two connection faces, the at least two identical magnetic field generators emitting a magnetic field having a characteristic representative of the module ID.

14. The gaming apparatus of claim 13, wherein the magnetic field generator comprises a set of magnets defining a unique arrangement of polarity values and intensity values representative of the module ID.

15. The gaming apparatus of claim 14, wherein each of the at least two proximity sensing units comprises a set of magnetic field sensors for detecting the set of magnets of the gaming module and thereby obtaining the module ID of the gaming module.

16. The gaming apparatus of claim 14, wherein each of the at least two proximity sensing units comprises a set of magnetically activable switches for detecting the set of magnets of the gaming module, and thereby obtaining the module ID of the gaming module.

17. The gaming apparatus of claim 12, wherein each of the at least two identifier units comprises a set of bodies representative of the module ID; and
wherein each of the at least two proximity sensing units comprises a set of capacitive sensors for detecting the set of bodies of the gaming module and thereby obtaining the module ID of the gaming module.

18. The gaming apparatus of claim 17, wherein the set of bodies comprise at least one of:
at least one conductive plate; and
at least one non-conductive plate.

19. The gaming apparatus of claim 12, wherein the processor is configured for determining the face ID by identifying a given one of the at least two sensing units that detects the connection with the other one of the modules.

20. (canceled)

21. The gaming apparatus of claim 12, further comprising at least one of a speaker and a light source, said action to be executed comprising one of emitting a sound via the speaker and activating the light source.

22. A method for detection a connection between a first gaming module and a second gaming module, the method being executed by a processor, the method comprising:
receiving from a first gaming module:
a first identification (ID) of a second gaming module;
a second ID of a given face of the first gaming module;
a third ID identifying the first gaming module;
receiving from the second gaming module:
the third ID of the first gaming module;
a fourth ID of a given face of the second gaming module;
a first ID of the second gaming module;
determining that the given face of the first gaming module is connected to the given face of the second gaming module based on the first ID, the second ID, the third ID and the fourth ID, thereby obtaining an identification result; and
triggering an event based on the identification result.

23.-25. (canceled)
